(19) United States
(12) Patent Application Publication
(10) Pub. No.: US 2011/0086959 A1
(43) Pub. Date: Apr. 14, 2011

(54) SHEAR THINNING PEROXIDE DISPERSIONS

(75) Inventors: Thomas H. Kozel, Pottstown, PA (US); Joseph M. Gravelle, Spring City, PA (US); Sri R. Seshadri, Holland, PA (US); Tomas Salvador, Sugar Lnd, TX (US)

(73) Assignee: Arkema Inc., Philadelphia, PA (US)

(21) Appl. No.: 12/989,828

(22) PCT Filed: Apr. 30, 2009
(86) PCT No.: PCT/US09/42201

§ 371 Date: Dec. 28, 2010

Related U.S. Application Data
(60) Provisional application No. 61/049,518, filed on May 1, 2008.

(51) Int. Cl. C08K 5/092; C09K 3/00

(52) U.S. Cl. 524/293; 252/182.12

(57) ABSTRACT

Provided are dispersions which comprise more than about (40) percent by weight of an organic peroxide which is normally solid, an effective dispersing amount of a pharmaceutically acceptable dispersing agent and water. The water and about (40) percent or more peroxide forms a paste. Addition of the dispersing agent/surfactant to a non-flowing organic paste resulted in the formation of a shear thinning aqueous dispersion. The aqueous dispersions can also contain optional components such as thickening agents and anionic emulsifiers.

### FIELD OF INVENTION

The present invention relates to pharmaceutically acceptable aqueous dispersions of normally solid organic peroxides. The dispersions are pastes which contain high concentrations of the peroxide. The pastes are shear thinning so as to be pumpable/pourable when mixed or stirred which makes their handling and use easier.

### BACKGROUND

Peroxides have, as a general property, a tendency to be flammable and explosive with some peroxides exhibiting such properties to a greater extent than others. For example, benzoyl peroxide may decompose when dry due to shock, friction, or static electricity. This property carries with it the obvious hazards to the users of these materials as well as to the manufacturers and intermediate handlers thereof. One particularly burdensome aspect of this property occurs during shipment of the peroxides. Accordingly, it has long been an object to provide flame resistant organic peroxide compositions. For example, U.S. Pat. No. 3,507,800 is directed to providing a flame resistant peroxide composition consisting essentially of three components—water, peroxide and solvent wherein the water is at least about 18 percent of the composition.

The safety and end-use advantage provided by water-soluble or water-emulsifiable peroxides is recognized. U.S. Pat. No. 3,825,509 describes a process for the suspension polymerization of vinyl chloride wherein the initiator is an aqueous emulsion of an organic peroxide in which the peroxide is present in an amount up to 19 weight percent. The surfactant used to prepare the aqueous peroxide emulsion is a combination of polyvinyl alcohol and polyoxyethylene sorbitan monolaurate. However, emulsions containing greater than about 19 percent by weight of organic peroxide are described as being too viscous and therefore difficult to handle.

There have been attempts in the past to make peroxide dispersions. U.S. Pat. Nos. 4,039,475 and 4,092,470 disclose stable, pumpable aqueous suspensions of organic peroxides using a mixture of a) nonionic emulsifiers having a maximum HLB value of 12.5 and b) nonionic emulsifiers having a minimum HLB value of 12.5 or anionic emulsifiers. U.S. Pat. No. 4,734,135 discloses aqueous suspensions of solid organic peroxides using a protective colloid, a surface active agent and water. U.S. Pat. No. 4,440,885 teaches emulsions of a solid organic peroxide using an emulsifier having an HLB value from about 9 to about 20, a hydrocarbon solvent and water.

Numerous other dispersions of solid organic peroxides are to be found in the art. Yet there is still a need for pharmaceutically acceptable aqueous dispersions containing high concentrations of solid organic peroxides that are pumpable/pourable.

### SUMMARY OF THE INVENTION

The present aqueous dispersions comprise more than about 40 percent by weight of an organic peroxide which is normally solid, an effective dispersing amount of a pharmaceutically acceptable dispersing agent and water. It was discovered that the addition of a dispersing agent/surfactant to a non-flowing organic paste resulted in the formation of a shear thinning aqueous dispersion. The aqueous dispersions can also contain optional components such as thickening agents and anionic emulsifiers.

### DESCRIPTION OF PREFERRED EMBODIMENTS

Aqueous dispersions of the present invention comprise an organic peroxide which is normally solid and a pharmaceutically acceptable dispersing agent/surfactant.

Exemplary of suitable organic peroxides are aromatic diacyl peroxides, such as benzoyl peroxide, o-methylbenzoyl peroxide, o-methoxybenzoyl peroxide, o-ethoxy benzoyl peroxide, o-chlorobenzoyl peroxide and 2, 4-dichlorobenzoyl peroxide; aliphatic diacyl peroxides, such as decanoyl peroxide, lauroyl peroxide and myristoyl peroxide; ketone peroxides, such as 1-hydroxy cyclohexyl peroxide and 1-hydroperoxycyclohexyl peroxide; aldehyde peroxides such as 1-hydroxy heptyl peroxide; peroxy dicarbonates such as dicetyl peroxydicarbonate, di(4-t-butylcyclohexyl) peroxydicarbonate and acylperoxy alkylcarbonates, such as acetyl peroxy stearyl carbonate and the like and mixtures thereof.

The present aqueous dispersions comprise about 40 percent or more by weight of an organic peroxide. One of the features of the present invention is that it enables the preparation of aqueous dispersions containing about 40 or more percent by weight of organic peroxide which dispersions are pumpable because they are shear thinning. Heretofore it has been difficult to make pumpable dispersions containing about 40 or more percent by weight organic peroxide. In this description, shear thinning means that viscosity drops as the shear rate increases. Thus, the viscosity of the peroxide dispersions of the present invention will drop as the dispersion is stirred or mixed and it becomes pourable or pumpable easing use.

A pharmaceutically acceptable dispersing agent refers to a dispersing agent that does not cause significant irritation to an organism and does not abrogate the biological activity and properties of an administered compound that the dispersion of the present invention is combined with.

Besides the water and organic peroxide, the composition of the present invention also comprise one or more pharmaceutically acceptable dispersing agents or surfactants in an amount of from about 0.5 to 2.0 wt %. A wide variety of pharmaceutically acceptable dispersing agents are useful herein and include those selected from the group consisting of anionic surfactants, nonionic surfactants, amphoteric surfactants, and mixtures thereof.

Nonlimiting examples of nonionic pharmaceutically acceptable dispersing agents or surfactants useful in the composition of the present invention include those selected from the group consisting of sodium lauryl ether sulfate, sodium lauryl sulfate, ethylene glycol monostearate, propylene glycol myristate, glyceryl monostearate, glyceryl stearate, polyglyceryl-4-oleate, sorbitan acylate, sucrose acylate, PEG-150 laurate, PEG-400 monolaurate, polyoxyethylene monolaurate, polysorbates, polyoxyethylene octylphenylether, PEG-1000 cetyl ether, polyoxyethylene tridecyl ether, polypropylene glycol butyl ether, Polyethlylene-polypropylene glycol, stearoyl monoisopropanolamide, polyoxyethylene hydrogenated tallow amide, polyoxyethylene fatty acid esters (Tweens), the block copolymers of polyoxypropylene and polyoxyethylene, also known as (Pluronics), polyoxyethylene castor oil derivatives, sorbitan fatty acid ester (including sorbitan laurate, sorbitan oleate, sorbitan palmitate, sorbitan stearate and the like), and mixtures thereof.

Nonlimiting examples of amphoteric pharmaceutically acceptable dispersing agents or surfactants useful in the composition of the present invention include those selected from the group consisting of sodium N-dodecyl-beta-alanin-e, sodium N-lauryl-beta-iminodipropionate, myristoamphoacetate, lauryl betaine and lauryl sulfobetaine.

Nonlimiting examples of anionic pharmaceutically acceptable dispersing agents or surfactants useful in the compositions of the present invention include those selected from the group consisting of sarcosinates, sulfates, isethionates, taurates, phosphates, lactylates, glutamates, and mixtures thereof. Another suitable class of anionic surfactants are the water-soluble salts of the organic, sulfuric acid reaction products of the general formula: R1-SO₃-M wherein R1 is chosen from the group consisting of a straight or branched chain, saturated aliphatic hydrocarbon radical having from about 8 to about 24, preferably about 10 to about 16, carbon atoms; and M is a cation. Still other anionic synthetic surfactants include the class designated as succinamates, olefin sulfonates having about 12 to about 24 carbon atoms, and b-alkyloxy alkane sulfonates. Examples of these materials are sodium lauryl sulfate and ammonium lauryl sulfate.

Other anionic materials include phosphates such as monoalkyl, dialkyl, and trialkylphosphate salts.

Other anionic materials include alkanoyl sarcosinates corresponding to the formula RCON(CH₃)CH₂CH₂CO₂M wherein R is alkyl or alkenyl of about 10 to about 20 carbon atoms, and M is a water-soluble cation such as ammonium, sodium, potassium and alkanolamine (e.g., triethanolamine), a preferred examples of which are sodium lauroyl sarcosinate, sodium cocoyl sarcosinate, ammonium lauroyl sarcosinate, and sodium myristoyl sarcosinate. TEA salts of sarcosinates are also useful.

Also useful as pharmaceutically acceptable dispersing agents are taurates which are based on taurine, which is also known as 2-aminoethanesulfonic acid. Especially useful are taurates having carbon chains between C₈ and C₁₆. Examples of taurates include N-alkyltaurines such as the one prepared by reacting dodecylamine with sodium isethionate according to the teaching of U.S. Pat. No. 2,658,072 which is incorporated herein by reference in its entirety. Further nonlimiting examples include ammonium, sodium, potassium and alkanolamine (e.g., triethanolamine) salts of lauroyl methyl taurate, myristoyl methyl taurate, and cocoyl methyl taurate.

Also useful as pharmaceutically acceptable dispersing agents are lactylates, especially those having carbon chains between C₈ and C₁₆. Nonlimiting examples of lactylates include ammonium, sodium, potassium and alkanolamine (e.g., triethanolamine) salts of lauroyl lactylate, cocoyl lactylate, lauroyl lactylate, and caproyl lactylate.

Also useful as pharmaceutically acceptable dispersing agents are anionic surfactants comprising glutamates, especially those having carbon chains between C₈ and C₁₆. Nonlimiting examples of glutamates include ammonium, sodium, potassium and alkanolamine (e.g., triethanolamine) salts of lauroyl glutamate, myristoyl glutamate, and cocoyl glutamate.

Nonlimiting examples of preferred anionic surfactants useful herein include those selected from the group consisting of sodium lauryl sulfate, ammonium lauryl sulfate, ammonium laureth sulfate, sodium laureth sulfate, sodium trideceth sulfate, ammonium cetyl sulfate, sodium cetyl sulfate, ammonium cocoyl isethionate, sodium lauroyl isethionate, sodium lauroyl lactylate, triethanolamine lauroyl lactylate, sodium caproyl lactylate, sodium lauroyl sarcosinate, sodium myristoyl sarcosinate, sodium cocoyl sarcosinate, sodium lauroyl methyl taurate, sodium cocoyl methyl taurate, sodium lauroyl glutamate, sodium myristoyl glutamate, and sodium cocoyl glutamate and mixtures thereof.

### EXAMPLES

### Example 1

An aqueous solution of 50% by weight benzoyl peroxide and 0.25% by weight polysorbate 20 was prepared and allowed to stand for two weeks. Viscosity was measure with a Brookfield viscometer, using an RV-3 spindle at 10 rpm at 20° C. The viscosity after standing was about 8,5000-10,000 centipoise. After vigorous shaking the viscosity dropped to about 2,450-3,100 centipose.

### Example 2

Aqueous solutions of 50% by weight benzoyl peroxide were prepared having 0, 0.25, 0.50 and 1.00% by weight polysorbate 20. The viscosity of each solution was measured with a Brookfield viscometer using a TC spindle at 1.5 rpm at 20° C., helipath. The viscosities are summarized in Table 1.

TABLE 1

| Weight % Polysorbate 20 | Viscosity (cps) |
|---|---|
| 0.0 | >600,000 |
| 0.25 | 68,000-70,000 |
| 0.50 | 59,000-62,000 |
| 1.00 | 46,000-50,000 |

What is claimed is:

1. An aqueous dispersion comprising about 40% by weight or more of an organic peroxide and about 0.5 to 2.0% by weight of a pharmaceutically acceptable surfactant.

2. The aqueous dispersion of claim 1 wherein said organic peroxide is selected from the group consisting of aromatic diacyl peroxides, aliphatic diacyl peroxides, ketone peroxides, aldehyde peroxides, peroxy dicarbonates, acylperoxy alkylcarbonates and mixtures thereof.

3. The aqueous dispersion of claim 2 wherein said aromatic diacyl peroxide is selected from the group consisting of benzoyl peroxide, o-methylbenzoyl peroxide, o-methoxybenzoyl peroxide, o-ethoxy benzoyl peroxide, o-chlorobenzoyl peroxide and 2, 4-dichlorobenzoyl peroxide.

4. The aqueous dispersion of claim 2 wherein said aliphatic diacyl peroxide is selected from the group consisting of decanoyl peroxide, lauroyl peroxide and myristoyl peroxide.

5. The aqueous dispersion of claim 2 wherein said ketone peroxide is selected from the group consisting of 1-hydroxy cyclohexyl peroxide and 1-hydroperoxycyclohexyl peroxide.

6. The aqueous dispersion of claim 2 wherein said aldehyde peroxide is 1-hydroxy heptyl peroxide.

7. The aqueous dispersion of claim 2 wherein said peroxy dicarbonate is selected from the group consisting of dicetyl peroxydicarbonate and, di(4-t-butylcyclohexyl) peroxydicarbonate.

8. The aqueous dispersion of claim 2 wherein said acylperoxy alkylcarbonates is acetyl peroxy stearyl carbonate.

9. The aqueous dispersion of claim 1 wherein said pharmaceutically acceptable surfactant is selected from the group consisting of anionic surfactants, nonionic surfactants, amphoteric surfactants, taurates, lactylates, glutamates and mixtures thereof.

10. The aqueous dispersion of claim 9 wherein said nonionic surfactant is selected from the group consisting of sodium lauryl ether sulfate, sodium lauryl sulfate, ethylene glycol monostearate, propylene glycol myristate, glyceryl monostearate, glyceryl stearate, polyglyceryl-4-oleate, sorbitan acylate, sucrose acylate, PEG-150 laurate, PEG-400 monolaurate, polyoxyethylene monolaurate, polysorbates, polyoxyethylene octyiphenylether, PEG-1000 cetyl ether, polyoxyethylene tridecyl ether, polypropylene glycol butyl ether, Polyethlylene-polypropylene glycol, stearoyl monoisopropanolamide, polyoxyethylene hydrogenated tallow amide, polyoxyethylene fatty acid esters, the block copolymers of polyoxypropylene and polyoxyethylene, polyoxyethylene castor oil derivatives, sorbitan fatty acid esters, and mixtures thereof.

11. The aqueous dispersion of claim 10 wherein said sorbitan fatty acid ester is selected from the group consisting of sorbitan laurate, sorbitan oleate, sorbitan palmitate and sorbitan stearate.

12. The aqueous dispersion of claim 9 wherein said amphoteric surfactant is selected from the group consisting of sodium N-dodecyl-beta-alanin-e, sodium N-lauryl-beta-iminodipropionate, myristoamphoacetate, lauryl betaine and lauryl sulfobetaine.

13. The aqueous dispersion of claim 9 wherein said anionic surfactant is selected from the group consisting of sarcosinates, sulfates, isethionates, taurates, phosphates, lactylates, glutamates and mixtures thereof.

14. The aqueous dispersion of claim 9 wherein said anionic surfactant is selected from the group consisting of water-soluble salts of the organic, sulfuric acid reaction products of the general formula: R₁—SO₃-M wherein R₁ is chosen from the group consisting of a straight or branched chain, saturated aliphatic hydrocarbon radical having from about 8 to about 24 carbon atoms; and M is a cation.

15. The aqueous dispersion of claim 14, wherein said saturated aliphatic hydrocarbon radical has from 10 to about 16 carbon atoms.

16. The aqueous dispersion of claim 9 wherein said anionic surfactant is selected from the group consisting of succinamates, olefin sulfonates having about 12 to about 24 carbon atoms, and b-alkyloxy alkane sulfonates.

17. The aqueous dispersion of claim 9 wherein said anionic surfactant is selected from the group consisting of alkanoyl sarcosinates of the formula RCON(CH₃)CH₂CH₂CO₂M wherein R is alkyl or alkenyl of about 10 to about 20 carbon atoms, and M is a water-soluble cation.

18. The aqueous dispersion of claim 17 wherein said alkanoyl sarcosinate is selected from the group consisting of ammoniumamine, sodiumamine, potassiumamine and alkanolamine.

19. The aqueous dispersion of claim 18 wherein said alkanoyl sarcosinate is selected from the group consisting of sodium lauroyl sarcosinate, sodium cocoyl sarcosinate, ammonium lauroyl sarcosinate and sodium myristoyl sarcosinate.

20. The aqueous dispersion of claim 9 wherein said taurate is selected from the group consisting of ammonium, sodium, potassium and alkanolamine salts of: lauroyl methyl taurate, myristoyl methyl taurate, and cocoyl methyl taurate and N-alkyltaurine.

21. The aqueous dispersion of claim 9 wherein said lactylate is selected from the group consisting of ammonium, sodium, potassium and alkanolamine salts of: lauroyl lactylate, cocoyl lactylate, lauroyl lactylate, and caproyl lactylate.

22. The aqueous dispersion of claim 9 wherein said glutamate is selected from the group consisting of ammonium, sodium, potassium and alkanolamine salts of: lauroyl glutamate, myristoyl glutamate, and cocoyl glutamate.

23. The aqueous dispersion of claim 9 wherein said anionic surfactant is selected from the group consisting of sodium lauryl sulfate, ammonium lauryl sulfate, ammonium laureth sulfate, sodium laureth sulfate, sodium trideceth sulfate, ammonium cetyl sulfate, sodium cetyl sulfate, ammonium cocoyl isethionate, sodium lauroyl isethionate, sodium lauroyl lactylate, triethanolamine lauroyl lactylate, sodium caproyl lactylate, sodium lauroyl sarcosinate, sodium myristoyl sarcosinate, sodium cocoyl sarcosinate, sodium lauroyl methyl taurate, sodium cocoyl methyl taurate, sodium lauroyl glutamate, sodium myristoyl glutamate, and sodium cocoyl glutamate and mixtures thereof.
